(19) United States
(12) Patent Application Publication
(10) Pub. No.: US 2004/0169978 A1
(43) Pub. Date: Sep. 2, 2004

(54) Overcurrent trip device comprising the detection of the waveform of a current to be monitored

(76) Inventor: Jeffery C. Mizener, Sidney, OH (US)

Correspondence Address: HARNESS, DICKEY & PIERCE, P.L.C., P.O.BOX 8910, RESTON, VA, 20195, US

(21) Appl. No.: 10/475,605

(22) PCT Filed: Mar. 26, 2002
(86) PCT No.: PCT/DE02/01157

(30) Foreign Application Priority Data
Apr. 23, 2001 (DE) 101 20 751.4

(51) Int. Cl. H02H 3/08

(52) U.S. Cl. 361/93.1

(57) ABSTRACT

The invention relates to a circuit breaker (1) comprising an overcurrent trip device (4) with a protective module, (6), whose long time delay is influenced by the proportion of harmonic waves in the current to be monitored. To control the dependency of the trip delay on the harmonic wave content, invention is provided with an adjustment device (9), by means of which a user determines the parameters (A) and (B). Parameter (A) is a limiting value for the harmonic wave content of the current. If said limiting value is exceeded, the trip delay is reduced. The degree of dependency of the trip delay on the harmonic wave content is selected by the additional parameter (B).

### DESCRIPTION

The invention relates to an overcurrent tripping apparatus having a protective module for outputting a control signal to a power breaker in order to open switching contacts of the power breaker as a function of a predetermined current/time characteristic.

An overcurrent tripping apparatus such as this, as is described in U.S. Pat No. 5,600,527, has the object of preventing lines and loads from being damaged by being overloaded. The protective module causes the switching contacts in the power breaker to open, thus interrupting an electric circuit to be protected when the current and the duration of the current flow exceed limit values set for them.

When determining the abovementioned current/time characteristic it is assumed that the objects or operational equipment, such as cables or motors, to be protected are supplied with single- or three-phase alternating current at a fixed frequency, and that the current is sinusoidal. However, loads having a nonlinear characteristic and causing the waveform of the current to be distorted, are present in the electrical power supply systems. The harmonic content of the current (THD=Total Harmonic Distortion) can be regarded as a measure of this distortion, i.e. the proportion of the current which is at a higher frequency than the fundamental frequency of the power supply system (50 or 60 Hertz). Specific parts of the electrical equipment, in particular the cables, are heated to a greater extent by this harmonic content of the current than corresponds to the arithmetical loading by the r.m.s. value of the current on the resistance in the cable. In this case, a reasonable level of protection can be achieved only by setting the tripping delay of the overcurrent tripping apparatus of a power breaker to a deliberately lower value.

This adjustment, however, only applies to the harmonic content that occurred on that occasion and must be matched afresh when, for example, other loads are operated in the power supply system. With the power breaker according to the abovementioned U.S. Pat No. 5,600,527, in which the tripping occurs as a function of a predetermined current/time characteristic, the harmonic content of the current (THD) is determined and indicated to the user at the same time.

In another known overcurrent tripping apparatus in the form of a harmonic overcurrent relay, provision is made for a control signal to be output when the current value and the duration of two individual harmonic disturbances in the current to be monitored exceed limit values set for them. In this case, provision is further made, when the control signal is output, for the harmonic content only to be taken into account when the current values of the two individual harmonic disturbances each exceed a likewise predetermined peak value which is selected by adjustment (U.S. Pat No. 4,903,163).

However, it has been shown that the sensitivity of the loads and cables to harmonics may differ widely. Therefore, it is possible for too little or too much allowance to be made for the respective harmonic content for a given item of equipment (cable, motor, other loads), and therefore for the overcurrent tripping apparatus to respond too early or too late.

An overcurrent tripping apparatus having the features of the preamble of claim 1 (U.S. Pat No. 4,903,163) is used as the basis for the object of the invention of improving the allowance for a harmonic content of a current to be monitored and for thereby improving the safety of the equipment.

This object is achieved according to the invention by the protective module of the overcurrent tripping apparatus for taking into account the characteristics of an electric circuit to be protected using the waveform of the current which is present in each case having an associated adjustment apparatus for a correction factor which is dependent on the waveform of the current, the control signal being output as a function of a current/time characteristic which is influenced by the correction factor.

The correction factor in the context of the invention is a load sensitivity factor (load sensitivity for short). The value of the long time delay of the predetermined current/time characteristic of the overcurrent tripping apparatus can in this case be multiplied by the load sensitivity factor. If the load sensitivity factor is 1, this means that the predetermined or standardized current/time characteristic is used unchanged. When there are harmonics in the current to be monitored, however, the load sensitivity is less than 1.

This load sensitivity factor is therefore a very clear and reliable aid for the user of the overcurrent tripping apparatus for correcting the setting of the overcurrent tripping apparatus. For example, a load sensitivity of 0.9 means that the tripping delay is reduced by 10% in order to allow for the additional heating of an item of equipment by harmonics.

The “load sensitivity” adjustment factor can be specified in accordance with a development of the invention by two equally clear parameters which are therefore safe for the user to use. For this purpose, the adjustment apparatus can have separate adjustment elements, one adjustment element serving the purpose of determining a limit value for the harmonic content, which is determined from the waveform of the current, above which limit value the tripping delay is influenced, whilst the further adjustment element serves the purpose of determining the degree of dependence of the tripping delay on the harmonic content.

In the context of the invention, a dedicated circuit unit, which is supplied with sample values of the current as input variables, can be provided for determining the harmonic content and the load sensitivity, the protective module being controlled by the value of the determined load sensitivity. Provision may be made, in a modification of this circuit, for the circuit unit to receive sample values of the current once they have been conditioned in the protective module.

In addition, in the context of the invention, a particularly simple circuit design can be achieved by the protective module carrying out the calculation of the harmonic content as a subroutine of a microprocessor device, and by the result being taken into account as a working step in a process for determining the overcurrent tripping which is subject to a long time delay.

The invention is explained in more detail below with reference to the exemplary embodiment shown in the figures.

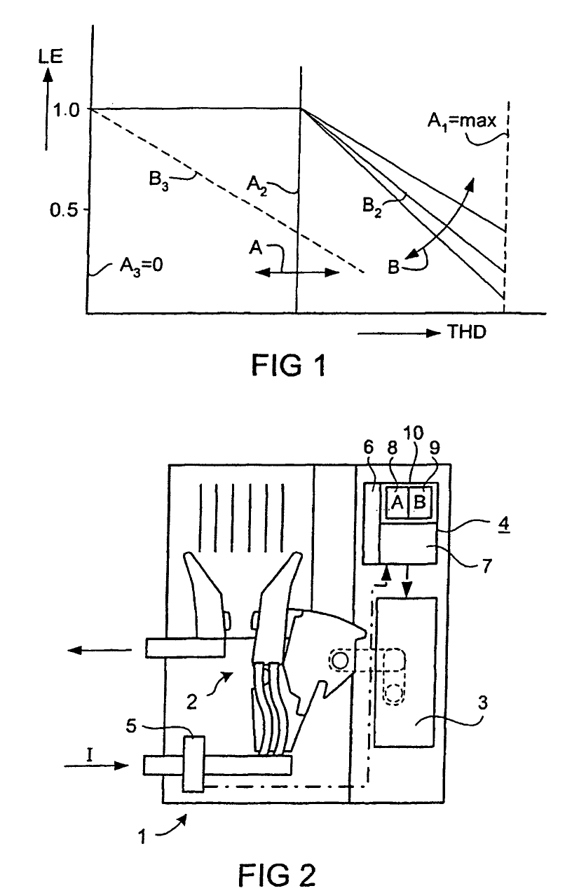

FIG. 1 shows a diagram of the relationship between a tripping apparatus and the harmonic content of a current to be monitored.

FIG. 2 shows a schematic of a power breaker having an overcurrent tripping apparatus and having the functions explained with reference to FIG. 1.

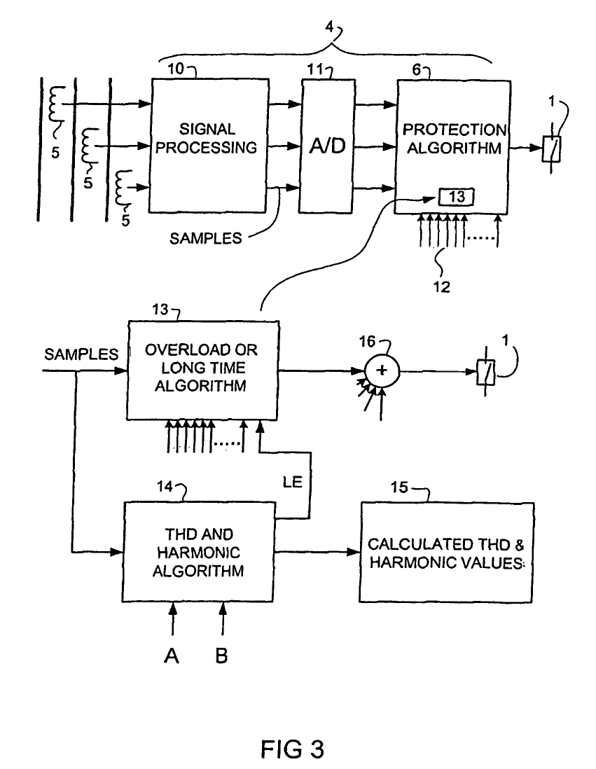

FIG. 3 shows a block diagram of the basic configuration of an electronic overcurrent tripping.

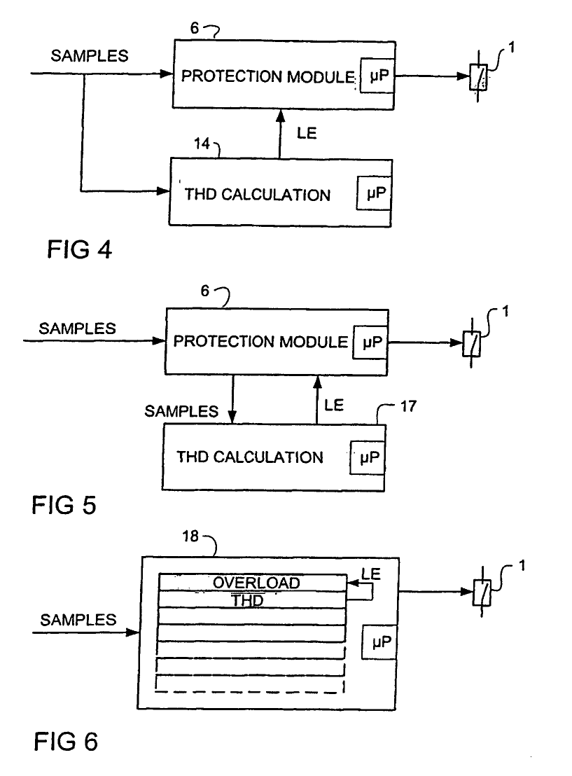

FIGS. 4 and 5 show different circuit units for calculating the harmonic content.

FIG. 6 shows a protective module that processes all of the protective functions, including the dependence of the tripping time on the harmonic content.

The diagram in FIG. 1 shows a variable, denoted load sensitivity LE, as a function of the harmonic content of a current to be monitored. A correction factor is in this case defined as the load sensitivity LE and is multiplied by the overcurrent response value (Long Time Delay). If LE is less than 1, this means that the overcurrent tripping apparatus trips the power breaker at a value which is lower than the standard value. For a given current (average value or r.m.s. value), the tripping delay is thus reduced.

The load sensitivity LE is determined by two parameters A and B which can be adjusted independently of one another and which characterize, in a manner which is clear to the user, the characteristics of an item of equipment to be protected. The parameter A determines the harmonic content value of the current, above which the tripping delay is to be reduced, i.e. the load sensitivity is reduced. FIG. 1 shows this by means of a dashed line denoted A.

Furthermore, the parameter B determines the level or degree of dependence of the tripping delay on the harmonic content, and is defined in accordance with FIG. 1 as the gradient angle of the characteristic. A small gradient angle means here that the item of operational equipment is not greatly influenced by harmonics, whilst a large gradient angle indicates a correspondingly greater influence of harmonics on the item of equipment.

Three items of equipment will be considered as examples whose properties differ as indicated. In the first case, it is assumed that the item of equipment is one which is “insensitive to harmonics”. In the sense of the above explanations, this item of equipment has a load sensitivity of 1 in the entire range of harmonic content under consideration i.e. the parameter A is set by the user to an upper value A₁. It is therefore not necessary to adjust the parameter B which can, however, alternatively be set to “0” (no gradient angle).

Another example is an item of equipment which is “sensitive to harmonics”. This has a limit value A₂ and an angle B₂ other than 0. The sensitivity of the item of equipment can be seen in the diagram shown in FIG. 1 from the position of A₂ and the size of the gradient angle B₂.

If, by way of a third example, an item of equipment which is “highly sensitive to harmonics” is assumed, any harmonic content leads to a reduction in the load sensitivity LE. This means that the parameter A₃=0 and the parameter B₃ differs from 0 to a greater or lesser degree.

The functional correlations can be seen in more detail in FIG. 2 which shows a sectional schematic of a low-voltage power breaker 1. In the power breaker 1, the closing and opening of switching contact systems 2 is controlled by a drive apparatus 3. This drive apparatus 3 has an associated overcurrent tripping apparatus 4 which has two or more functional groups. These functional groups are supplied with a measured value of the current by means of a current transformer 5 which detects the current flowing through the power breaker. A protective module 6 determines the tripping delay with which the drive apparatus 3 opens the switching contact systems 2, as a function of the harmonic content and according to the load sensitivity LE which are selected by the user by means of the mentioned parameters A and B, using adjustment elements 7 and 8 of an adjustment apparatus 9.

Details of the new operation of the overcurrent tripping apparatus 4 can be seen in FIG. 3, which shows a circuit unit 10, downstream of the current transformers 5, for signal conditioning, an analog/digital converter 11 and the protective module 6 mentioned as the major units. A number of parameters 12 are supplied to the protective module 6, as is known. Associated with the different channels or types of tripping is the long time delay 13 which is of particular interest in this context, is referred to as a subunit and is shown in more detail in the lower part of FIG. 3. The long time delay unit 13 can for its part be subjected to a number of different parameters and is influenced in particular by a circuit unit 14 which determines the harmonic content of the current using the sample values supplied. At the same time, the results of these calculations are made available for display on a display unit 15. A logic unit 16 indicates that criteria calculated at a different point or using other processes within the overcurrent tripping 4 are taken into account for tripping the power breaker 1.

FIG. 4 shows, once again in simplified form, that the harmonic calculation is carried out in a circuit unit 14 using the same sample values as those also supplied to the protective module 6. As a modification of this circuit arrangement, FIG. 5 shows a modified circuit unit 17 which processes conditioned sample values in the protective module 6 itself in order to calculate the load sensitivity LE.

A third, but not final, possible way of calculating the harmonic content is shown in FIG. 6, in which the calculation of the harmonic content can also be carried out by means of a modified protective module 18 which takes account of the load sensitivity internally. This solution is particularly suitable when the protective tasks are less complex and thus the computational power of the microprocessor device in the protective module is sufficient for the additional function. On the other hand, it can be expedient with regard to the simplified overall configuration to select the solution shown in FIG. 6 even in the case of complex protective functions, using a microprocessor having a higher computational power.

### List of Reference Symbols

A Parameter for limit value of the harmonic content

B Parameter for the degree of dependence of the tripping delay on the harmonic content

LE Load sensitivity

1 THD Total harmonic content

2 Low-voltage power breaker

3 Switching contact system

4 Drive apparatus

5 Overcurrent tripping apparatus

6 Current transformer

7 Protective module

8 Adjustment element for the parameter A

9 Adjustment element for the parameter B

10 Adjustment apparatus for load sensitivity

11 Circuit unit for signal conditioning

11 analog/digital converter

12 Parameters (general)

13 Long time delay unit

14 Circuit unit for harmonic detection

15 Display unit for harmonics

16 Logic unit

17 Circuit unit for harmonic detection (modified configuration)

18 Modified protective module

1. An overcurrent tripping apparatus (4) having a protective module (6; 18) for outputting a control signal to a power breaker (1) in order to open switching contacts (2) of the power breaker (1) as a function of a predetermined current/time characteristic and of a continuously detected waveform of the current (I) to be monitored,
characterized in that
the protective module (6; 18) of the overcurrent tripping apparatus (4) for taking into account the characteristics of an electric circuit to be protected using the continuously detected waveform of the current has an associated adjustment apparatus (9) for a correction factor which is dependent on the waveform of the current,
the control signal being output as a function of a current/time characteristic which is influenced by the correction factor.

2. The overcurrent tripping apparatus as claimed in claim 1,
characterized in that
the adjustment apparatus (9) has separate adjustment elements (7, 8), one adjustment element (7) serving the purpose of determining a limit value (A) for the harmonic content (THD), which is determined from the waveform of the current (I), above which limit value (A) the tripping delay of the predetermined current/time characteristic is influenced, and a further adjustment element (8) serving the purpose of determining the degree of dependence (B) of the tripping delay on the harmonic content (THD).

3. The overcurrent tripping apparatus as claimed in 1 or 2,
characterized in that
a dedicated circuit unit (14; 17), which is supplied with sample values of the current as input variables, is provided for determining the harmonic content and the correction factor, and in that the protective module (6) is controlled by the value of the determined correction factor.

4. The overcurrent tripping apparatus as claimed in claim 3,
characterized in that
the circuit unit (17) is supplied with sample values of the current once they have been conditioned in the protective module (6).

5. The overcurrent tripping apparatus as claimed in claim 1,
characterized in that
the protective module (18) carries out the calculation of the harmonic content (THD) as a subroutine of a microprocessor device, and the result is taken into account as a working step in a process for determining the overcurrent tripping which is subject to a long time delay.
